(19) United States
(12) Patent Application Publication
(10) Pub. No.: US 2009/0078215 A1
(43) Pub. Date: Mar. 26, 2009

(54) Non-medical in home monitoring method for diabetic cats and dogs

(76) Inventor: Verla Gail Lash, Abington, PA (US)

Correspondence Address: JAMES RAY & ASSOCIATES, 2640 PITCAIRN ROAD, MONROEVIILLE, PA, 15146, US

(21) Appl. No.: 12/151,255

(22) Filed: May 5, 2008

Related U.S. Application Data
(60) Provisional application No. 60/994,702, filed on Sep. 21, 2007.

(51) Int. Cl. A01K 13/00; A61D 99/00

(52) U.S. Cl. 119/712

(57) ABSTRACT

A non-medical in-home monitoring method for diabetic cats and dogs. The method comprises the steps registering a pet as a client with a veterinarian and a technician. The method includes the steps having such pet owner recording frequency of urination for waking and sleeping hours and sending results to the technician. Having technician compile results for a period of time and plot results on a graph. Having owner and veterinarian review results. Meet with such veterinarian for a behavior medication review wherein the veterinarian will adjust the insulin dosage if deemed necessary.

### CROSS REFERENCE TO RELATED APPLICATIONS

This application is closely related to and claims benefit from U.S. Provisional Application Ser. No. 60/994,702 filed Sep. 20, 2007.

### FIELD OF THE INVENTION

The present invention relates, in general, to a home monitoring tool, and, more particularly, the present invention relates to a non-medical home monitoring tool for diabetic cats and dogs.

### BACKGROUND OF THE INVENTION

The care of a diabetic cat or dog requires the pet owner to adhere to a strict schedule for the administration of insulin, food, and the pet's exercise. This care includes continuous time consuming pet monitoring for signs of diabetes mellitus. The care is both an emotional and financial investment.

Such special needs of the diabetic pet include an initial hospitalization and repeat hospitalizations, the monthly supply of syringes and insulin, prescription only diets, bi-weekly or monthly vet appointments, special care products, such as three 21 pound bags of kitty litter each week per cat and monthly Frontline plus to eliminate skin infections caused by fleas and ticks for both cats and dogs.

Effective diabetes regulation can lower the diabetic pet's health care costs. This is evidenced in the following ways: the regulated diabetic pet requires infrequent hospitalizations and there is a decrease in the frequency of veterinarian appointments. The decline in feline polyuria frequency is directly correlated with a decrease in kitty litter purchases. Cosmetic benefits include improvement in environmental hygiene and fewer time consuming clean up tasks. Lastly, effective regulation of the disease leads to lengthening of the pet's life span and life quality.

Thus, it would be advantageous if there were a monitoring tool or method for diabetic pets that could produce effective diabetes regulation.

### SUMMARY OF THE INVENTION

The present invention provides a method for non-medical in-home monitoring of diabetic cats and dogs. The method comprises the steps of registering a pet as a client by an owner of said pet with a veterinarian and assigning a technician to such pet owner for explaining all concepts of the in-home monitoring protocol. There is a step of providing technical support to the pet owner by the technician and a step of recording observations on frequency of urination by the pet during waking hours and sleeping hours separately by the pet owner and a step of forwarding the results of the observations determined in the previous step to the technician. There is a step of plotting an average frequency of urination during the waking hours and the sleeping hours on a polyuria graph by the technician and a step of sending the results compiled after a predetermined period of time by the technician to the veterinarian and to the pet owner for review. This is followed by the step of having a meeting at the veterinarians office with the pet owner, the pet and the veterinarian for a behavior medication review and a step of adjusting insulin dosage, if deemed necessary, for such pet by the veterinarian in the meeting with the pet owner and pet.

### OBJECTS OF THE INVENTION

It is, therefore, one of the primary objects of the present invention to provide an in-home monitoring procedure for diabetic cats and dogs.

Another object of the present invention is to provide a working team that includes the pet owner, a technician and a veterinarian.

Still another object of the present invention is to provide a method for monitoring polyuria.

Yet another object of the present invention is to provide the pet owner with the means to more effectively care for their diabetic pet.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a block diagram of a concept map for the non-medical in-home monitoring method for diabetic cats and dogs.

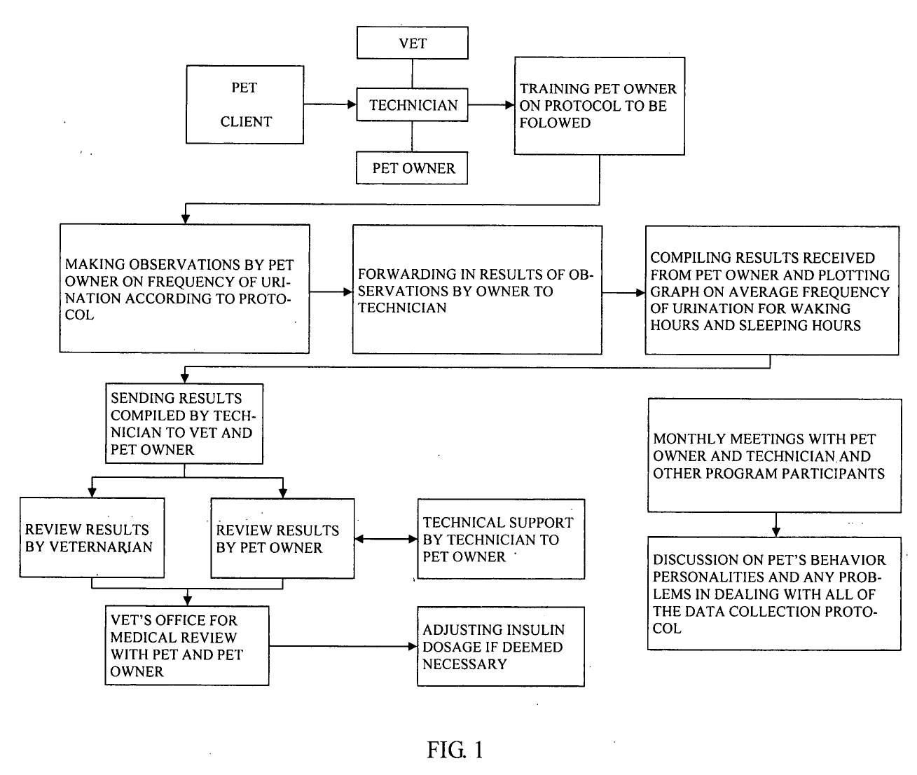

FIG. 2 is a an example of a polyuria data collection chart.

FIG. 3 is an example of a polyuria chart made up after a predetermined period of time showing average frequency of urination during waking hours and sleeping hours.

### BRIEF DESCRIPTION OF THE PRESENTLY PREFERRED AND VARIOUS ALTERNATIVE EMBODIMENTS OF THE INVENTION

The present invention provides a method for non-medical in-home monitoring of diabetic cats and dogs. The method comprises the steps of registering a pet as a client by an owner of said pet with a veterinarian and assigning a technician to such pet owner for explaining all concepts of the in-home monitoring protocol. There is a step of providing technical support to the pet owner by the technician and a step of recording observations on frequency of urination by the pet during waking hours and sleeping hours separately by the pet owner and a step of forwarding the results of the observations determined in the previous step to the technician.

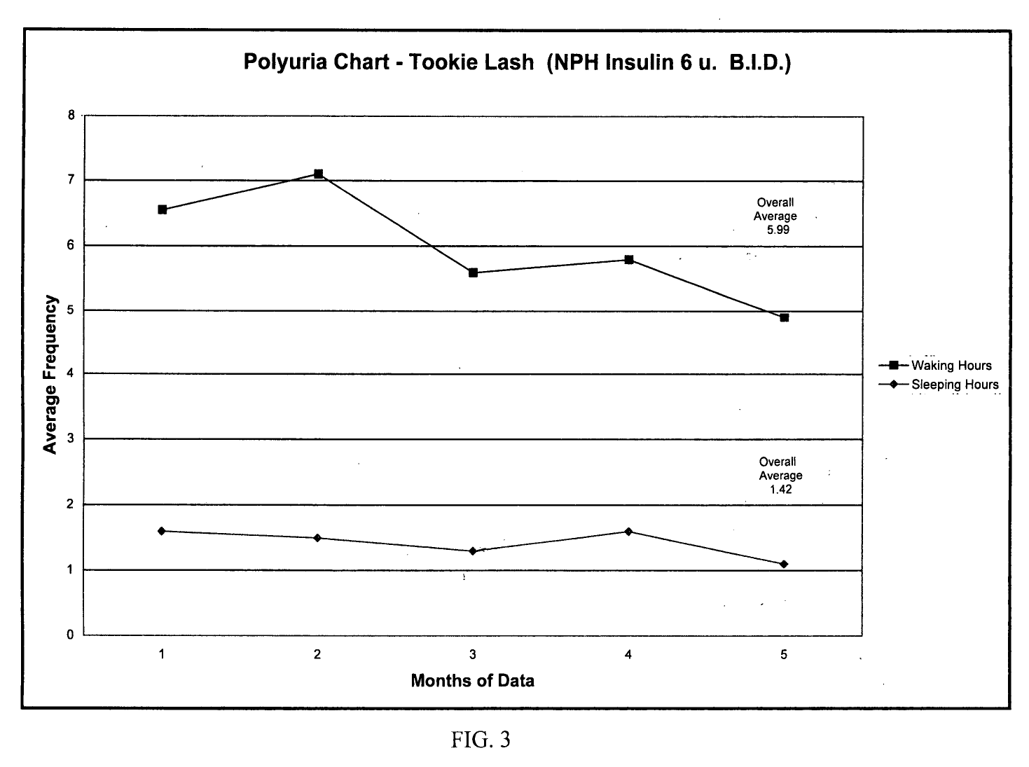

There is a step of plotting an average frequency of urination during the waking hours and the sleeping hours on a polyuria graph by the technician and a step of sending the results compiled after a predetermined period of time by the technician to the veterinarian and to the pet owner for review. FIG. 3 is an example of the graph prepared by the technician after a predetermined period of time that indicates the average frequency of urination during waking and sleeping hours. This is followed by the step of having a meeting at the veterinarians office with the pet owner, the pet and the veterinarian for a behavior medication review and a step of adjusting insulin dosage, if deemed necessary, for such pet by the veterinarian in the meeting with the pet owner and pet.

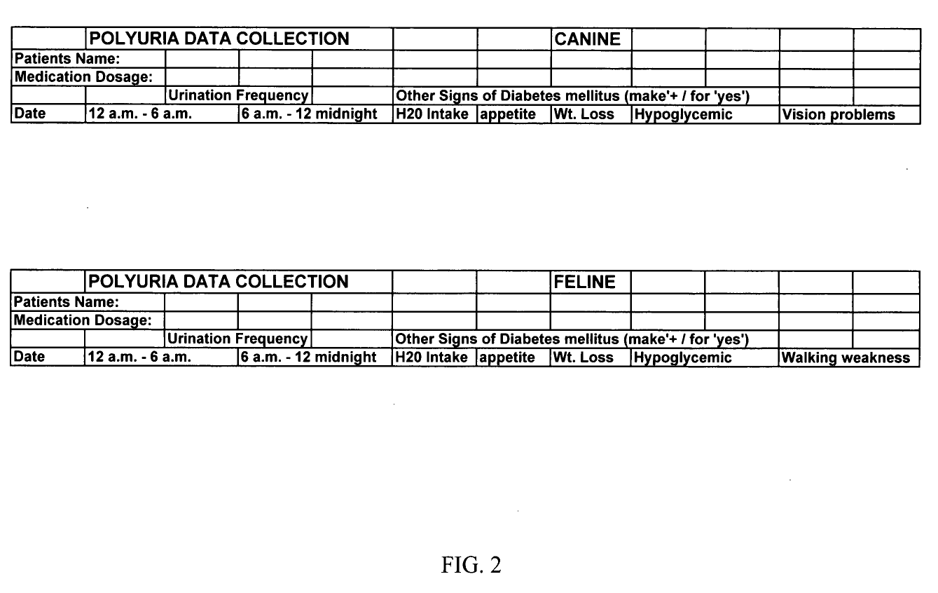

The method includes a step of teaching said pet owner how to accurately count urination incidents as part of the technical support to the pet owner by the technician. The method also includes a step of such pet owner agreeing to complete the homework assignment form on the frequency counts of polyuria along with marks for other signs of diabetes mellitus. FIG. 2 shows an example of polyuria monitoring chart that is used by the owner to mark the incidence of urination during waking hours and sleeping hours. There is, further, a step of the technician being available for weekly support conversations with the pet owner.

The method also includes an additional step of inviting the pet owner to attend monthly meetings with the technician along with other program participants and a step of encouraging the program participants in such monthly meetings to discuss their pets behavior personalities along with problems that they may have encountered in dealing with the high maintenance at-home care and data collection protocol for their diabetic pets.

The idea of the in-home monitoring tool for diabetic cats or dogs is a non-medical technique for providing data on the independent variables (insulin dosage, food, exercise) and dependent variables (in this case, polyuria is the outcome variable). The monitoring tool (method) is for the pet owner who does not want to introduce additional invasive techniques on the pet as a monitoring device. This monitoring method requires minimal time and effort for the pet owner. A graph is generated from the raw data and presented at the appointment with the veterinarian. At the behavior medication review, the insulin efficacy is readily assessed via the graph and the qualitative summary of the other signs of diabetes mellitus. The decision to make insulin dosage changes is thus expedited, accurate, simple and concise.

One problem that a pet owner generally encounters is that he/she will rely upon faulty memory, anecdotal comments, or no meaningful information is contributed while reporting on the health status of their pet during a appointment with the veterinarian. Incomplete information is often unreliable. Efficacious insulin therapy is adversely affected because of the important missing puzzle pieces. The protocol of the method provides the following: a visual product that demonstrates improvement or regression and the intricate relationship between the continuum of care, the disease symptomatology and medication in layman's terms.

This non-medical in-home monitoring method for diabetic cats and dogs accurately translates qualitative or verbal material into one quantitative graph. Presenting information in visual form such as a graph is a helpful supplement to verbal material and is not overwhelming with medical detail. It is quick, non-threatening for the intellect and to the point. This visual aid is relevant to the diabetic pet's symptoms and it helps all members of the treatment team with organizing all the bits and pieces of information received since the most recent assessment period.

The veterinarian, obviously, is the team leader. The polyuria protocol is a tangible contribution for the medical review. The pet owner's dedication, empowerment and accountability are increased because of this collaborative and interdependent process.

This monitoring tool helps the pet owner focus on the one target behavior (polyuria) for frequency counts. The other signs of diabetes mellitus are placed on the back burner and this makes the entire process less burdensome with the pet owner's time and effort. The veterinarian is responsible for all of the medical tests and the pet owner is responsible for food and insulin administration, and behavior observations that consist of accurate recording of the outcome variable (polyuria), and casual attention to the other signs of diabetes mellitus.

Thus, the present invention provides a treatment team consisting of the diabetic cat or dog, the pet owner, the veterinarian and the technician.

The technician introduces and explains all concepts listed on the non-medical in-home monitoring tool for diabetic cats and dogs to the pet owner and the vet. The technician provides in-home technical support to the pet owner for accuracy in recording observations. This includes how to count urination incidents during the two periods of the 24 hour day (12 a.m.-6:00 a.m., waking hours) and (6:00 a.m.-12 midnight, sleeping hours).

In addition ‘+’ marks indicating ‘yes’ are recorded on the section designated as Other Signs of Diabetes Mellitus on the data collection sheet. The pet owner agrees to do the daily homework assignments of frequency counts for polyuria and ‘+’ marks indicating ‘yes’ for the Other Signs of Diabetes Mellitus.

Upon completion of the daily homework assignment form, the pet owner forwards the forms to the technician for data analysis via Excel by Windows. The technician is available for weekly support conversations with the pet owner. These contacts will be faded to monthly as time progresses and as the pet owners confidence increases.

Upon completion of the technician's assessment, the polyuria graph and summary of the Other Signs of Diabetes Mellitus are forwarded to the pet owner and to the veterinarian, This transaction is done two weeks prior to the next appointment with the veterinarian.

At the veterinarian's office, the pet, pet owner and the veterinarian are present for the behavior medication review. The protocol obtained from the non-medical in-home monitoring tool for the diabetic cat or dog is presented and reviewed as well as all medical tests done by the veterinarian. The veterinarian then decides any insulin medication adjustments or maintenance at this time.

The pet owner is invited to attend monthly meetings with the technician and other special program participants. This is a quality control meeting/support group titled “TookiLuv Group.” The participants are encouraged to share pets' pictures and personalities, and how the are dealing with the demands of the high maintenance at-home care and the data collection protocol. The purpose of this all volunteer group meeting is to energize the positive outlook of the caretakers, to put a fresh face on compassionate care and to improve the lives of the diabetic cat or dog as well as the pet owners.

In the monitoring the “waking hours” represent the hours between 6:00 A.M. until about 12 midnight (which is considered an average day time). Sleeping hours on the graph represents the hours between midnight and 6:00 A.M. (average sleep hours).

The frequency of urination is monitored by slash marks: 1,1,1,1, . . . etc. Following every incident of urination into the “kitty box”, the pet owner makes a mark into the appropriate section of the data sheet (this is the “waking hours) section or the “sleeping hours” section). If the pet owner is not present to document immediately after every urination, there is always visual evidence of urination represented by a large dark gummy area.

Pet owners may not be available to document the frequency of urination during sleeping hours, but there should be documentation before the beginning of the 6:00 A.M. hour. It is very important that the litter box have no urination evidence before the midnight hour. This will ensure polyuria accuracy during the sleeping hours.

Canine frequency counts are easier to count because the dogs usually urinate outdoors or on the potty training pads that some owners frequently use. Used training pads are usually removed after each use. The owners are also required to document the frequencies of polyuria on the appropriate sections of the data collection sheet. Overnight, the pet owner usually offer the canine several training pads or escort the pet outdoors for urination.

It should be noted that the technician post is not a medical person but is a person that is relatively well versed in math and statistics and also in preparing graphs.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. A method for non-medical in-home monitoring of diabetic cats and dogs, said method comprising the steps of:
(a) registering a pet as a client by an owner of said pet;
(b) assigning a technician to said pet owner for explaining all concepts of the in-home monitoring tool;
(c) providing technical support to the pet owner by said technician;
(d) recording observations on frequency of urination by said pet during waking hours and sleeping hours separately by said pet owner;
(e) forwarding the results of observations determined in step (d) to said technician;
(f) plotting average frequency of urination during said waking hours and said sleeping hours on a polyuria graph by said technician;
(g) sending results compiled by said technician after a predetermined period of time to a veterinarian and to said pet owner for review;
(h) meeting with said pet owner, said pet and said veterinarian for behavior medication review; and
(i) adjusting insulin dosage, if deemed necessary, for said pet by said veterinarian in said meeting with said pet owner and said pet.

2. The method, according to claim 1, wherein said technical support includes a step of teaching said pet owner how to accurately count urination incidents.

3. The method, according to claim 1, wherein said method includes a step of said pet owner agreeing to complete the homework assignment form of frequency counts of polyuria and marks for other signs of diabetes mellitus.

4. The method, according to claim 1, wherein said method includes a step of said technician being available for weekly support conversations with said pet owner.

5. The method, according to claim 1, wherein said method further includes a step of inviting said pet owner to attend monthly meetings with said technician and program participants.

6. The method, according to claim 1, wherein said method includes a step of encouraging said participants in said monthly meeting on such pets behavior personalities and problems encountered with dealing with the high maintenance at-home care and data collection protocol for said diabetic pets.
